(19) United States
(12) Patent Application Publication
(10) Pub. No.: US 2023/0323555 A1
(43) Pub. Date: Oct. 12, 2023

(54) METAL-MATRIX COMPOSITES

(71) Applicants: Majid Minary Jolandan, Dallas, TX (US); Mohammadreza Mahmoudi, Tempe, AZ (US)

(72) Inventors: Majid Minary Jolandan, Dallas, TX (US); Mohammadreza Mahmoudi, Tempe, AZ (US)

(21) Appl. No.: 18/297,308

(22) Filed: Apr. 7, 2023

Related U.S. Application Data
(60) Provisional application No. 63/328,692, filed on Apr. 7, 2022.

(51) Int. Cl. C25D 5/02; C04B 35/10; C04B 35/14; C04B 40/00; C04B 41/00; C25D 5/00

(52) U.S. Cl. CPC C25D 5/02; C04B 35/10; C04B 35/14; C04B 40/0078; C04B 41/0072; C04B 40/0071; C25D 5/67

(57) ABSTRACT

A metal-ceramic composite includes a ceramic matrix defining a multiplicity of pores, and a metal electrodeposited in the multiplicity of pores. A ceramic slurry includes ceramic microstructures or nanostructures, silica nanopowder, a dispersant, and a binder. Repairing a void in a metal-ceramic composite, wherein the void is defined by at least a first metal surface and a second metal surface of the metal-ceramic composite, includes introducing a solution including metal ions into the void, and electrodepositing the metal ions on the first metal surface and the second surface to yield a metal phase, thereby filling the void.

### CROSS-REFERENCE TO RELATED APPLICATION

This application claims the benefit of U.S. Patent Application No. 63/328,692 filed on Apr. 7, 2022, which is incorporated herein by reference in its entirety.

### STATEMENT OF GOVERNMENT SUPPORT

This invention was made with government support under grant 2152732 awarded by the National Science Foundation and grant FA9550-20-1-0280 awarded by the Air Force Office of Scientific Research. The government has certain rights in the invention.

### TECHNICAL FIELD

This invention relates to metal-ceramic composites, as well as methods for making and repairing the metal-ceramic composites.

### BACKGROUND

Ceramics are strong, resistant to high temperatures, and chemically stable. Most ceramics have limited ductile behavior. For example, surface or internal defects such as cracks can form in certain ceramic components either during processing or under load in applications. These cracks can act as fracture initiation sites, thereby deteriorating the fracture strength of the ceramic components.

### SUMMARY

This disclosure describes methods for preparation of electrically conductive metal-ceramic composites, as well as methods for repairing the metal-ceramic composites. In one aspect, freeze-casting is used to fabricate large sheets of alumina scaffolds. The scaffolds are infused with metal using an electrodeposition process. Cracks generated mechanically can be repaired using an electrodeposition process similar to or the same as that used to fabricate the metal-ceramic composites. Repair of the metal-ceramic composites can be achieved at room temperature. In one implementation, local repair of a void in a metal-ceramic composite is achieved by coating a portion of the metal-ceramic composite with an electrically non-conductive material, leaving an exposed electrically conductive surface proximate the void, and electrodepositing metal in the void. In this implementation, metal ions in solution migrate only toward the exposed electrically conductive surface under the influence of an electric field, and are reduced to solid metal and deposited, thereby filling the void.

In a first general aspect, a metal-ceramic composite includes a ceramic matrix defining a multiplicity of pores and a metal electrodeposited in the multiplicity of pores. The metal-ceramic composite is electrically conductive.

Implementations of the first general aspect can include one or more of the following features.

In some cases, the ceramic matrix includes alumina. The metal can include copper, nickel, gold, platinum, or any alloy thereof. In some implementations, the multiplicity of pores is filled with the metal. In some implementations, the first general aspect further defines microchannels within the metal-ceramic composite.

In a second general aspect, a ceramic slurry includes ceramic microstructures or nanostructures, silica nanopowder, a dispersant, and a binder.

Implementations of the second general aspect include one or more of the following features.

In some cases, the ceramic microstructures or nanostructures include platelets or whiskers. An average length of the microstructures or nanostructures can be at least twice an average thickness of the microstructures or nanostructures. The pH of the slurry can be in a range of about 5-7.5. In some implementations, a weight ratio of the silica nanopowder to the alumina platelets is in a range of about 0.1 to 0.2, a weight ratio of the binder to the alumina microplatelets is in a range of about 0.01 to about 0.05, and a weight ratio of the dispersant to the ceramic microstructures or nanostructures is in a range of about 0.001 to about 0.005.

In some implementations, fabricating a metal-ceramic composite includes freeze-casting the second general aspect to yield a freeze-cast slurry, drying the freeze-cast slurry to yield a freeze-dried slurry, sintering the freeze-dried slurry to yield a ceramic matrix defining a multiplicity of pores, and electrodepositing metal in the pores, thereby yielding the metal-ceramic composite. The second general aspect can further include compressing the freeze-dried slurry before sintering the freeze-dried slurry to control a density and a size of the pores. In some implementations, the compressing occurs perpendicular to a lamellar growth direction in the freeze-dried slurry, thereby compressing lamellae together to reduce a size of the pores. In some cases, after the compressing, a porosity of the freeze dried slurry is in a range of about 30% to about 50%. The sintering can occur at a temperature greater than a melting temperature of the silica nanopowder.

In a third general aspect, repairing a void in a metal-ceramic composite, wherein the void is defined by at least a first metal surface and a second metal surface of the metal-ceramic composite, includes introducing a solution including metal ions into the void, and electrodepositing the metal ions on the first metal surface and the second surface to yield a metal phase, thereby filling the void.

Implementations of the third general aspect can include one or more of the following features.

In some cases, introducing the solution into the void includes positioning the metal-ceramic composite in the solution. Introducing the solution into the void can include disposing a drop of the solution in the void. In some cases, introducing the solution into the void includes flowing the solution through one or more microchannels within the metal-ceramic composite. In some implementations, the third general aspect further includes, before introducing the solution into the void, detecting a presence of the void by assessing a change in electrical resistance of the metal-ceramic composite. In some cases, assessing the change in electrical resistance includes assessing the change with a sensor. In some implementations, the third general aspect further includes, after detecting the presence of a void, initiating the electrodeposition. The metal phase can include copper, nickel, gold, platinum, or any alloy thereof. In some implementations, electrodepositing the metal ions occurs at a temperature in a range of 20° C. to 30° C. The void can include a defect in the metal-ceramic composite.

The electrodeposition of metal used to fabricate and repair the disclosed composites is a low temperature and low cost process compared to traditional molten metal infiltration methods. The process localizes the repair to an area proximate the damage on the composite rather than requiring immersion of the entire sample into an electrolyte bath. The damage to the metal-ceramic composites can be sensed by measuring electrical resistivity. The methods disclosed herein are conducive to fully autonomic damage detection and repair of metal-ceramic composites.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic representation of metal infiltration by electrodeposition process.

FIG. 2A depicts the metal-ceramic composite defining a void (e.g., a defect, crack, or fracture). FIG. 2B depicts the repaired void filled with electrodeposited metal.

FIG. 3 is a schematic representation of the electrodeposition system configured for localized repair of the metal-ceramic composite.

FIG. 4A depicts a damaged (e.g., a defect, crack, or fracture) metal-ceramic composite with interior microchannels. FIG. 4B depicts the damaged area repaired with electrodeposited metal.

FIG. 5A depicts the position of microchannels inside the metal-ceramic composite. FIGS. 5B and 5C are images highlighting the patterns of internal microchannels.

FIG. 6A is an image demonstrating that current can flow through the metal-ceramic composite by lighting an LED connected to a current source across the metal-ceramic composite beam. FIG. 6B illustrates that a crack in the metal-ceramic composite can disrupt the current (electron) flow and alter electrical resistance. FIG. 6C is a plot of resistance measured across the metal-ceramic composite.

FIG. 7 is a plot of viscosity as a function of shear rate for a ceramic slurry.

FIG. 8 is a scanning electron microscopy (SEM) cross-sectional image of a ceramic matrix that shows the pore structure.

FIG. 9 shows cyclic voltammetry (CV) curves of the electrochemical cell before copper electrodeposition.

FIGS. 10A-10C are SEM images of the compressed samples fabricated using bi-directional freeze-casting. FIGS. 10A and 10B are images of the ceramic matrix in the absence of metal. FIG. 10C is an SEM image of metal-filed pores in the ceramic matrix. The bright regions are copper, and the dark regions are ceramic (alumina).

FIG. 11A is a schematic representation of the repair process for a machined grove on the metal-ceramic composite. FIG. 11B shows a side-view profile of the machined grooves on the beam surface measured with a profilometer. FIG. 11C is an SEM top-view image of a repaired groove. The inset is a higher magnification side-view image of the repaired groove.

FIG. 12A is a low magnification SEM image of a notched metal-ceramic composite beam after the repair process. FIGS. 12B-12D are higher magnification SEM images of the interface between the deposited metal and the metal-ceramic composite.

FIG. 13A is an SEM image of the interior of a crack in the metal-ceramic composite. The bright regions are copper and the dark regions are alumina. FIG. 13B shows a representative force-displacement plot of an intact beam and a repaired beam. The inset is a schematic representation of the electrical resistivity variation during damage evolution, damage detection, and electrochemical repairing.

FIGS. 14A-14E relate to nanoindendation tests on a metal-ceramic composite beam subjected to the electrodeposition local repair process. FIG. 14A is an SEM image of the repaired composite showing the regions of interest in the nanoindentation tests. FIG. 14B is a schematic of the regions of interest on the repaired beam showing the indentation array at specific locations. FIGS. 14C and 14D are plots of the hardness and elastic modulus, respectively, versus indentation number. FIGS. 14E and 14F show plots of the hardness and elastic modulus values, respectively, in three regions of interest on the repaired sample.

### DETAILED DESCRIPTION

This disclosure describes methods for preparation of electrically conductive metal-ceramic composites, as well as methods for repairing the metal-ceramic composites. In one aspect, freeze-casting is used to fabricate large sheets of alumina scaffolds. The scaffolds are infused with metal using an electrodeposition process. Cracks generated mechanically can be repaired using an electrodeposition process similar to or the same as that used to fabricate the metal-ceramic composites. Repair of the metal-ceramic composites can be achieved at room temperature. In one implementation, local repair of a void (e.g., a crack or groove) in a metal-ceramic composite is achieved by coating a portion of the metal-ceramic composite with an electrically non-conductive material, leaving an exposed electrically conductive surface proximate the void, and electrodepositing metal in the void. In this implementation, metal ions in solution migrate only toward the exposed electrically conductive surface under the influence of an electric field, and are reduced to solid metal and deposited, thereby filling the void. In one implementation, microchannels formed inside the metal-ceramic composites are used to transport a solution including metal ions to a void. The metal ions are electrodeposited to repair the void. The solution can be pumped through the microchannels from a reservoir external to the metal-ceramic composite, or the solution can be sealed within the metal-ceramic composite.

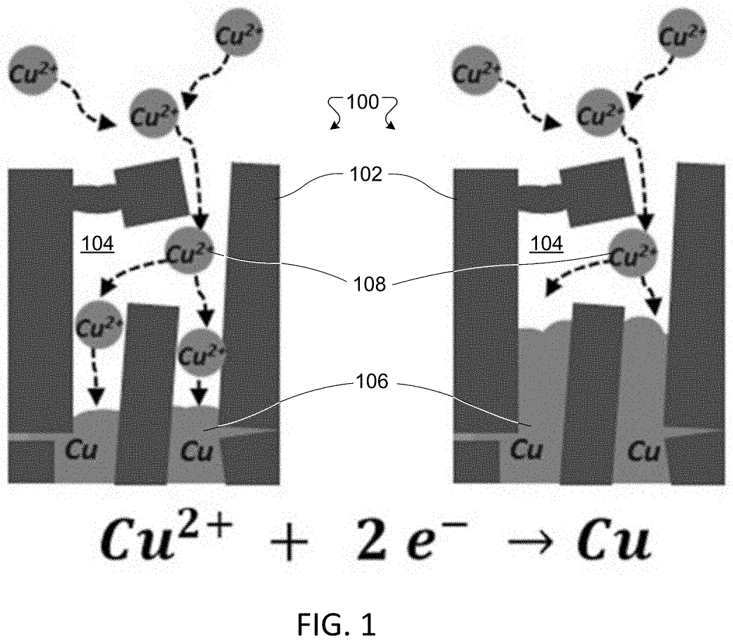

FIG. 1 depicts metal-ceramic composite 100 and the electrodeposition process used to fabricate and repair metal-ceramic composite 100. Ceramic matrix 102 defines a multiplicity of pores 104. Metal 106 (e.g., copper, nickel, gold, platinum or any alloy thereof) is electrodeposited in the multiplicity of pores 104. The metal-ceramic composite 100 is electrically conductive. Ceramic matrix 102 can include alumina. Electrodeposition fills multiplicity of pores 104 with metal 106.

Ceramic matrix 102 is fabricated using a ceramic slurry including ceramic microstructures or nanostructures, silica nanopowder, a dispersant, and a binder. The ceramic microstructures or nanostructures can include platelets or whiskers. An average length of the microstructures or nanostructures is at least twice an average thickness of the microstructures or nanostructures. The pH of the ceramic slurry is typically in a range of about 5-7.5. A weight ratio of the silica nanopowder to the alumina platelets is typically in a range of about 0.1 to 0.2. A weight ratio of the binder to the alumina platelets is typically in a range of about 0.01 to about 0.05. A weight ratio of the dispersant to the ceramic microstructures or nanostructures is typically in a range of about 0.001 to about 0.005.

Fabricating metal-ceramic composite 100 includes freeze-casting the ceramic slurry to yield a freeze-cast slurry, drying the freeze-cast slurry to yield a freeze-dried slurry, sintering the freeze-dried slurry to yield a ceramic matrix 102 defining a multiplicity of pores 104, and electrodepositing metal 106 in the multiplicity of pores 104, thereby yielding the metal-ceramic composite 100. Electrodepositing metal 106 includes filling the multiplicity of pores 104 with a solution including an electrolyte and metal ions 108. Metal ions 108 migrate toward the bottom of the electrolyte-filled multiplicity of pores 104 and are reduced to metal 106 to fill the pores toward the top surface of the ceramic matrix 102.

The fabrication can further include compressing the freeze-dried slurry before sintering the freeze-dried slurry to control a density and a size of the pores. The compressing can occur perpendicular to a lamellar growth direction in the freeze-dried slurry, thereby compressing the lamellae together to reduce a size of the pores. After the compressing, a porosity of the freeze dried slurry can be in a range of about 30% to about 50%. The sintering can occur at a temperature greater than a melting temperature of the silica nanopowder.

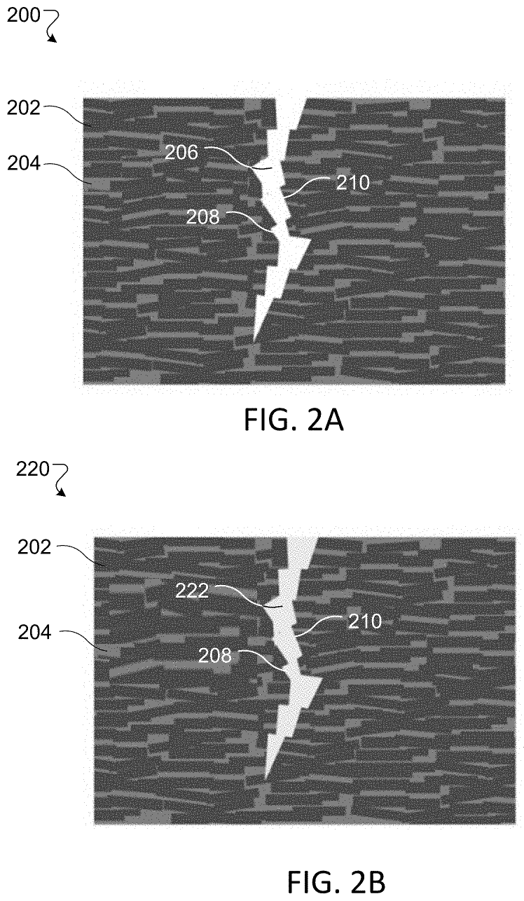

FIGS. 2A and 2B depict a metal-ceramic composite 200 defining a void (e.g., a defect, crack, or fracture) and a repaired metal-ceramic composite 220. The metal-ceramic composite includes ceramic microplatelets 202 defining a ceramic matrix. The multiplicity of pores defined by the ceramic matrix is filled by electrodeposited copper metal 204. Void 206 is defined at least by first metal surface 208 and second metal surface 210 of the metal-ceramic composite. The void 206 can include a defect in the metal-ceramic composite (e.g., a defect, crack, or fracture). The presence of the void can be assessed by determining electrical resistance between the first metal surface 208 and the second metal surface 210. Repairing metal-ceramic composite 200 can include introducing a solution including metal ions into the void, and electrodepositing the metal ions onto first metal surface 208 and second metal surface 210 to yield a metal phase, thereby filling void 206 with metal phase 222 (e.g., copper, nickel, gold, platinum, or any alloy therof). In one example, introducing the solution into the void includes positioning the metal-ceramic composite in the solution. In one example, introducing the solution into the void includes disposing a drop of the solution in the void. In one example, introducing the solution into the void includes flowing the solution through one or more microchannels within the metal-ceramic composite. Before introducing the solution into the void, a presence of the void can be detected by assessing a change in electrical resistance of the metal-ceramic composite. Assessing the change in electrical resistance can include assessing the change with a sensor. After detecting the void, the electrodepositing can be initiated. The electrodepositing can continue until assessing a change in the electrical resistance of the metal-ceramic composite indicates that the void has been filled with electrodeposited metal.

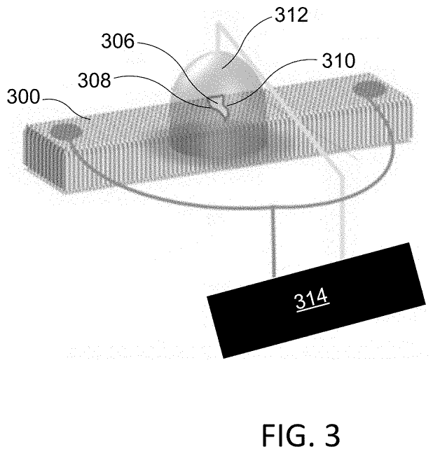

FIG. 3 illustrates the repair process of metal-ceramic composite 300. Metal-ceramic composite 300 defines void 306 (e.g., a defect, crack, or fracture) between first metal surface 308 and second metal surface 310. The metal-ceramic composite 300 is positioned in a solution 312 including metal ions. The solution 312 is electrically connected to potentiostat 314. Potentiostat 314 is electrically connected to the metal-ceramic composite 300. Metal-ceramic composite 300 serves as the cathode in the electric circuit. The metal ions in solution 312 are electrodeposited on first metal surface 308 and second metal surface 310, thereby filling void 306 with metal. The electrodepositing of the metal ions can occur at a temperature in a range of 20° C. to 30° C.

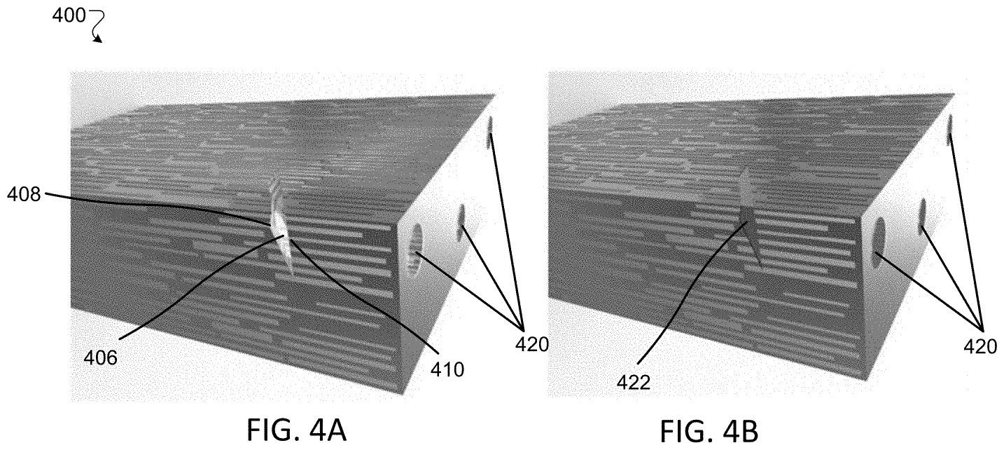

FIGS. 4A and 4B illustrate the repair process of a metal-ceramic composite 400 including internal microchannels 420. The metal-ceramic composite 400 defines a void 406 (e.g., a crack or fracture) defined by a first metal surface 408 and a second metal surface 410. Repairing metal-ceramic composite includes transporting a solution including metal ions through the microchannels 420 and electrodepositing the metal ions onto the first metal surface 408 and the second metal surface 410, thereby filling the void 406 with reduced metal phase 422. In one implementation, the solution is pumped through the microchannels from a reservoir external to the metal-ceramic composite. In one implementation, the solution is sealed within the metal-ceramic composite.

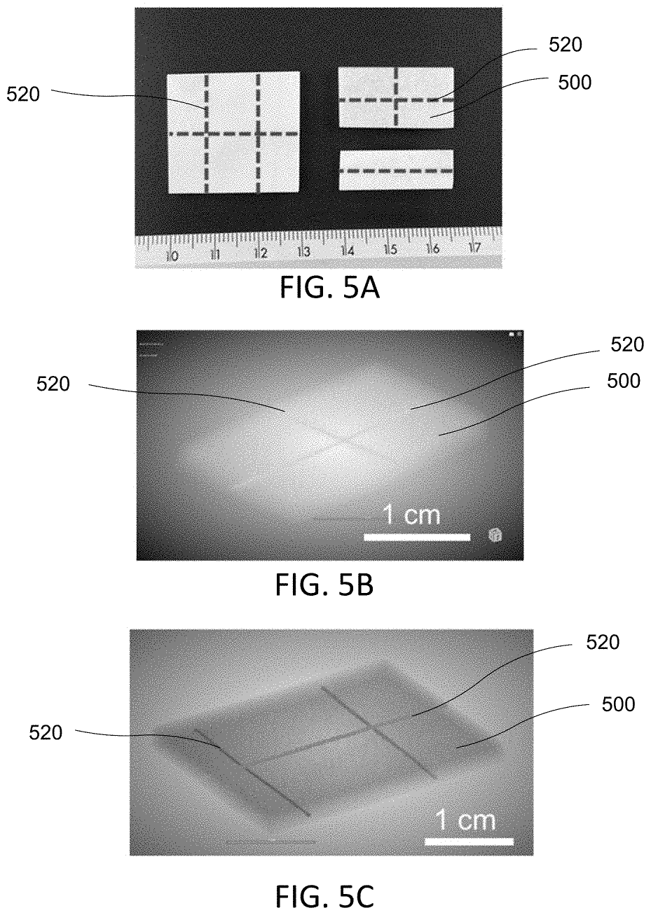

FIG. 5A depicts the position of internal microchannels 520 used to transport electrolyte solution inside the metal-ceramic composite 500 to repair damaged areas. FIGS. 5B and 5C are images highlighting the patterns of internal microchannels 520. The diameter of the microchannels can be in a range of about 100 microns to about 10 mm. The microchannels can be positioned along the length and width of the material. The microchannels can be made by 3D printing into the ceramic scaffold or drilling into the metal-ceramic composite after metal infiltration.

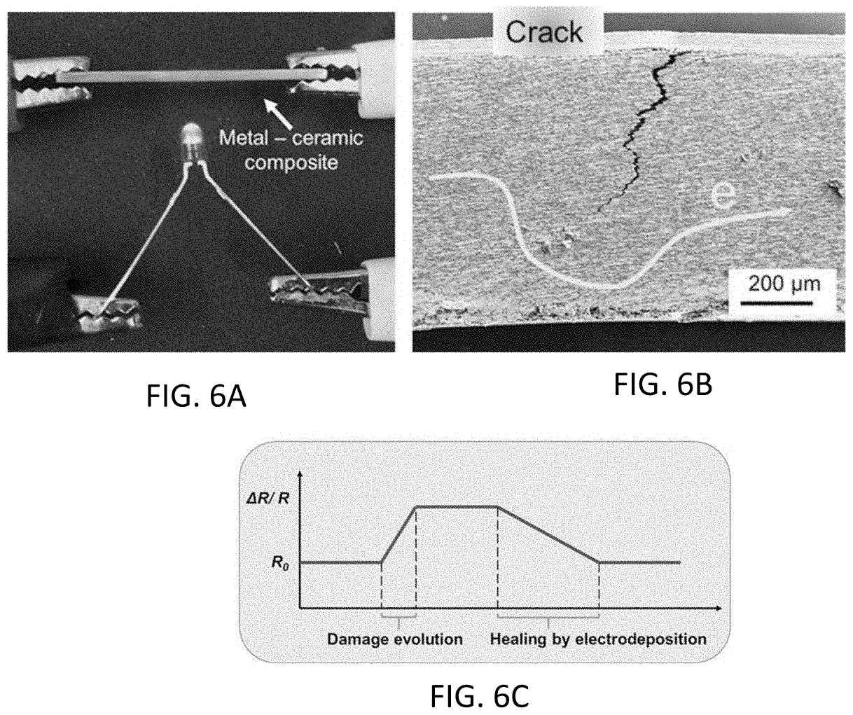

FIG. 6A is an image demonstrating that current can flow through the metal-ceramic composite by lighting an LED connected to a current source across the beam. FIG. 6B illustrates that a crack in the metal-ceramic composite can disrupt the current (electron) flow and alter electrical resistance. Damage to the metal-ceramic composite can be detected autonomously by sensing changes in the electrical resistance measured across the composite. Upon damage detection, autonomous repair can be achieved by contacting the damaged area with a solution including metal ions and electrodepositing metal in the damaged area as illustrated in FIGS. 3 and 4A-4B. FIG. 6C is a plot of resistance measured across the metal-ceramic composite showing an increase in resistance upon damage evolution and a decrease in resistance upon damage repair by metal electrodeposition.

### EXAMPLES

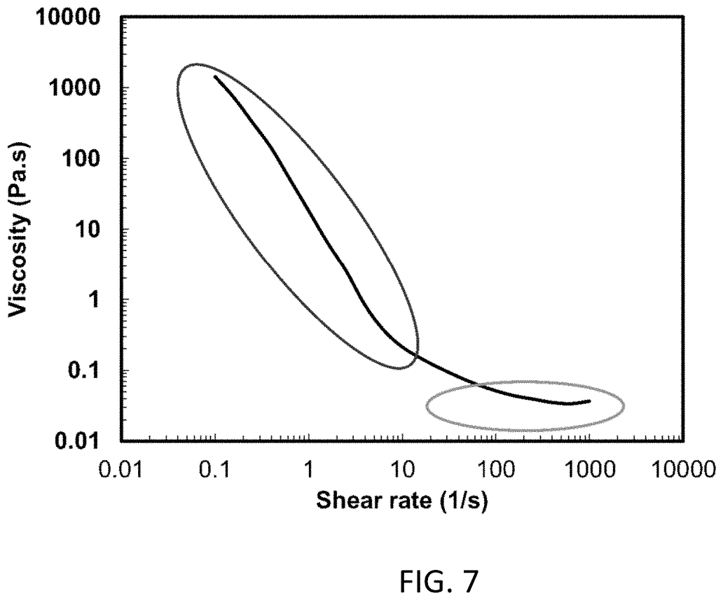

Metal-ceramic composite fabrication. A solid loading ceramic slurry was prepared by dissolving TAC (ammonium citrate tribasic) as the dispersant in deionized (DI) water. The dispersant in colloidal systems is selected to reduce or prevent the formation of agglomerations by controlling the interparticle forces influencing the stability of the ceramic slurry. Alginate was added to the solution as a binder. The presence of a binder in the system temporarily strengthens the green body during freeze drying as it could exhibit significant surface adherence. Alumina microplatelets with a mean diameter and thickness of about 6 μm and about 500 nm, respectively, were used. The alumina microplatelets and silica nanopowder were incrementally added to the solution and mixed in a planetary ball mill. The average diameter of the silica nanopowder was about 12 nm. To prevent breakage of the microplatelets, balls were not used in the planetary ball mill while mixing. This incremental addition of the powder produced a more homogeneous ceramic slurry. The rheology measurement of the ceramic slurry showed a shear thinning behavior, which is a characteristic of a stable slurry. FIG. 7 is a plot of viscosity as a function of shear rate for the ceramic slurry. The response shows a shear thinning behavior in the 0.2 to 10 s⁻¹ range followed by a Newtonian plateau in the 100 to 1000 s⁻¹ range, which is an indication of a stable slurry. The ceramic slurry was poured into a large mold. The mold was placed on one end of the cold finger of a freeze-casting apparatus. The opposite end of the cold finger was submerged in liquid nitrogen. After freeze-casting, the large thin sheet was cut into several 50 mm by 50 mm sheets that were then freeze-dried.

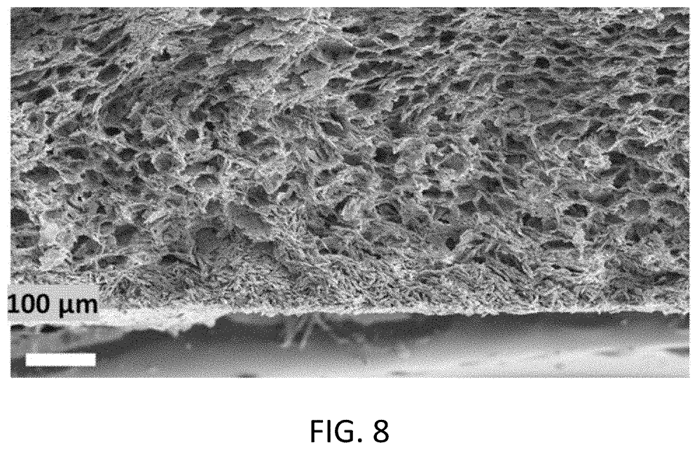

The freeze-dried samples were stacked onto each other in a furnace for the heating step. The heating step had two stages: binder burn-out and sintering. In the binder burn-out step, the alginate binder was completely removed in air at 600° C. These debinded samples were then heated to 1600° C. to sinter the alumina. In the sintering process, the driving force minimizes the surface energy by minimizing the surface area. Therefore, to facilitate consolidation, a liquid phase sintering aid was used. The liquid phase sintering aid melts at a lower temperature than the sintering temperature and provides paths for atomic diffusion between microplatelets. Silica nanoparticles were used as the liquid phase sintering aid. FIG. 8 is a scanning electron microscopy (SEM) cross-sectional image that shows the lamellar structure of the ceramic matrix inside sintered plates.

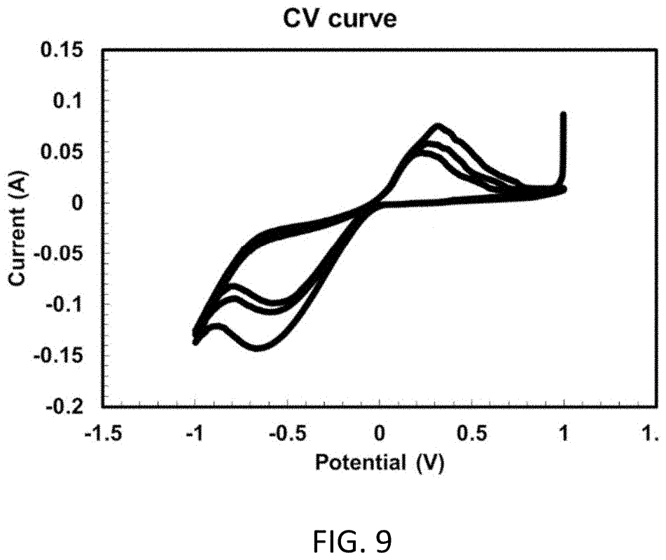

Electrodeposition was performed to fill the pores defined by the ceramic matrix with metal. The large, sintered scaffolds were polished, sonicated in deionized (DI) water and dried in a vacuum oven at 110° C. To make a cathode for electrodeposition process, the sintered scaffolds and glass slides were coated with chromium (Cr) and gold (Au) using an e-beam evaporator. A thin layer of Cr was deposited prior to Au deposition as an adhesion layer to enhance the adhesion between Au and glass substrate. The coated sides of the substrate and the scaffold were attached to each other to make the cathode for electrodeposition. The electrodeposition process was controlled with a potentiostat using galvanostatic technique at a current density of ˜8.6 mA/cm². This current density was obtained from the cyclic voltammetry plot as shown in FIG. 9. A copper mesh functioned as an anode where oxidation reaction occurred, and the scaffold served as the cathode where reduction reaction occurred. A NaCl reference electrode was used to form a three-electrode electrochemical cell. The electrodeposition process was monitored until the copper metal filled up the ceramic preform plate from the gold-coated side to the opposite side, through the thickness of the ceramic plate. Once over-deposition on the opposite side was observed, the electrodeposition was stopped. FIG. 1 shows a schematic of the metal infiltration by electrodeposition process. Metal ions 108 migrate inside electrolyte-filled pores 104 toward the bottom cathode and are reduced to metal 106 to fill up the pores 104 toward the top surface of ceramic matrix 102.

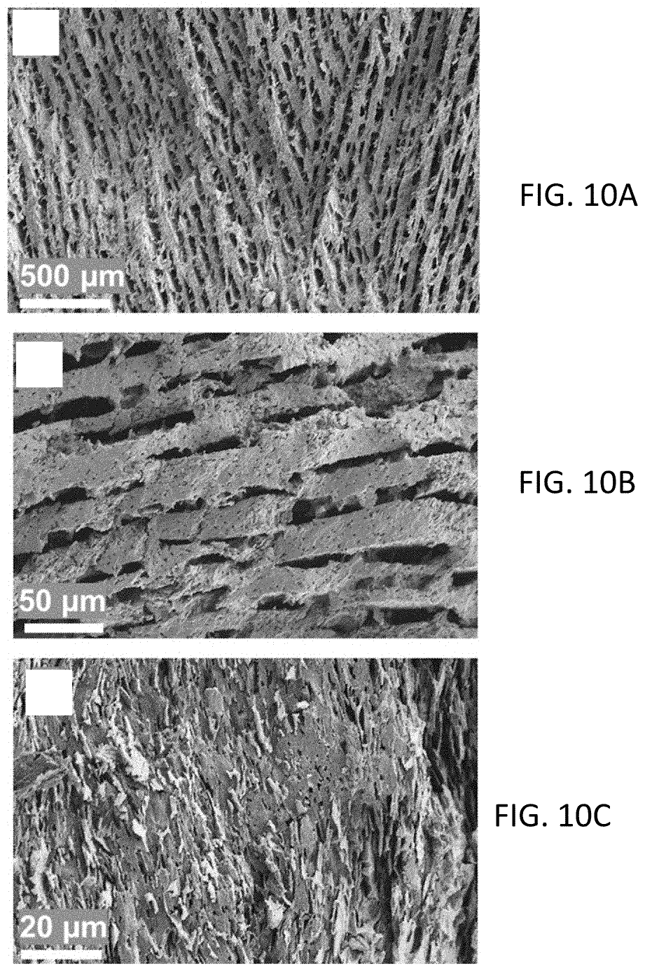

To make the green body, bi-directional freeze casting was used to fabricate the ceramic scaffold. In this method, a 20° polydimethylsiloxane (PDMS) wedge was placed on the bottom of the mold. The wedge provided a better lamella alignment compared to conventional freeze-casting. A mold with dimensions of 150 mm by 150 mm by 50 mm was used and filled with the aqueous ceramic slurry to a few millimeters. The freezing time increases with the depth of the slurry in the mold. In this way the slurry could be frozen in a few minutes as opposed to the several hours for deeper molds, and thus larger area ceramic preforms could be fabricated. After freeze-drying of the green body, the samples were compressed perpendicular to the ice lamellar growth direction. This compression step was used to provide an improved alignment of the ceramic microplatelets and results in a lamellar structure. FIGS. 10A and 10B show scanning electron microscope (SEM) images of the cross-section of the compressed scaffold depicting the effectiveness of the compression step in improving the alignment of the lamellar structure. The compression was 60% of the original length of the green body. After the compression stage, samples were heated as described earlier. The porosity in the compressed samples was 42%. This compression step was beneficial for several reasons. First, the material can have an improved alignment, which can result in better mechanical properties including strength and toughness. Second, the well-aligned lamellar structure can facilitate the electrochemical metal infiltration as it provides a less torturous path for the electrolyte to penetrate. The resulting scaffolds were filled with metal using the electrodeposition process as described earlier. FIG. 10C shows an SEM image of a metal-infiltrated ceramic preform. The bright regions are copper, and the dark regions are alumina.

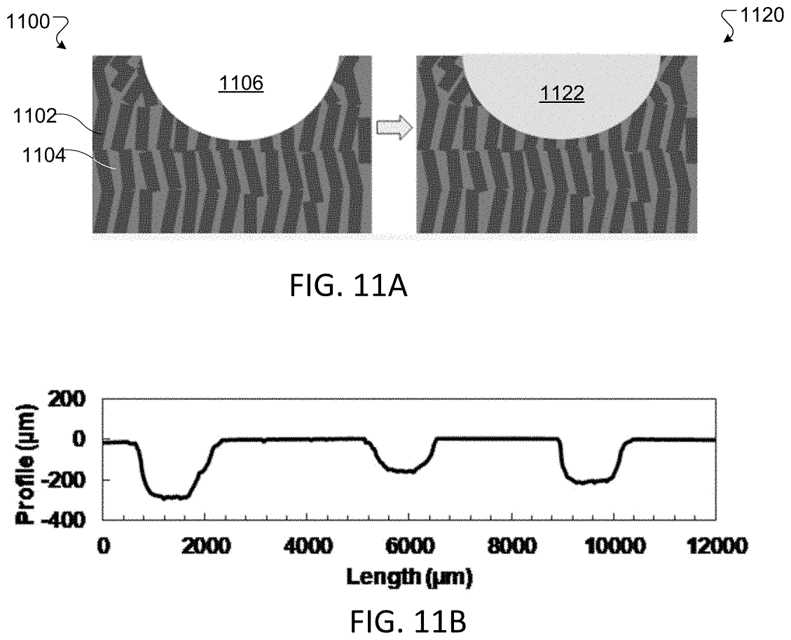

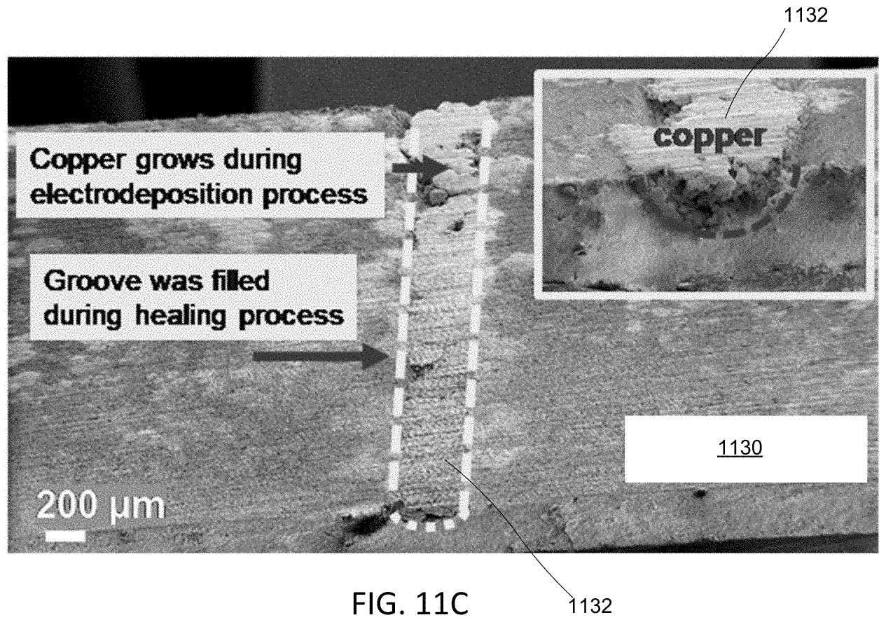

Metal-ceramic composite repair. Two types of damage encountered during use of ceramic materials include groove-type damage and fracture-crack type damage. To test the repair process for the first type of damage, grooves were machined in the metal-ceramic composites. The grooves could be controllably machined on the composite using micromilling without breaking or cracking the samples, which is an indication of the machinability of the composites. FIG. 11A is a schematic representation of a metal-ceramic composite before 1100 and after 1120 the repair of damage in the form of groove 1106. The metal-ceramic composite includes ceramic microplatelets 1102 defining a ceramic matrix. The multiplicity of pores defined by the ceramic matrix is filled by electrodeposited copper metal 1104. FIG. 11B shows the side-view profile of the machined grooves on the beam surface obtained by a profilometer. The grooves are ˜100-200 micron in depth and a few hundred microns in width. The electrodeposition process was used to fill the groove with metal 1122. For this purpose, the bottom side of each metal-ceramic composite beam specimen was used as cathode, similar to the infiltration process that was originally used to fabricate the composite. The copper ions selectively deposited on the conductive regions of the composite (e.g., copper) and filled the machined groove with copper metal 1122. After the deposition process was stopped, the over-grown depositions were polished. FIG. 11C shows a top-view SEM image of metal-ceramic composite 1130 with a groove after filling with electrodeposited metal 1132. The inset shows a high magnification SEM image of the cross-section of the metal-filled groove 1132. In this process, copper was deposited on a metal-ceramic composite surface. Since the ceramic phase (alumina) is non-conductive, copper can only deposit on the exposed copper on the surface of the groove. Hence, the quality of the deposited metal and the interface between the deposited metal and the original composite primarily depended on the surface conductivity of the original composite.

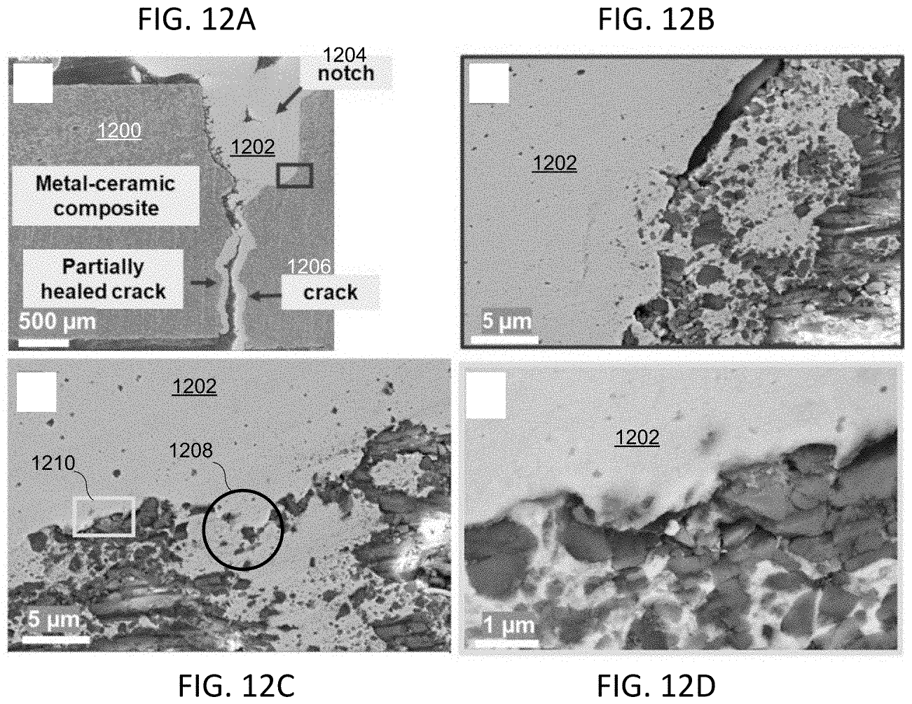

In a second test of damage typically encountered using ceramics, cracks were prepared in samples of the metal-ceramic composite. Initially, a notch was created on each beam, followed by 3-point bending. The presence of the notch facilitated initiation and propagation of the crack from the tip of the notch. The flexure experiments were continued until each beam fully fractured, which resulted in a notch-crack geometry that was used for repair test. Flexure fracture tests were first performed to generate a crack on notched metal-ceramic composite beams. The crack was then repaired using the same galvanostatic electrodeposition used to fill the grooves. For this purpose, two ends of each beam were connected to the cathode electrode of the potentiostat. FIGS. 2A and 2B are schematic representations of the electrochemical repair process of a crack in the metal-ceramic composite. FIGS. 12A-12D are SEM images of the cracked metal-ceramic composite after repair. The uniform bright regions are the deposited metal 1202, and the darker grey regions are the original metal-ceramic composite material 1200. Copper grows from adjacent surfaces of notch 1204 and crack 1206 and merges in the middle to repair the notch 1204 and the crack 1206. The notch 1204 is nearly fully filled, while the crack 1206 is partially filled. This could indicate that larger areas of damage may repair more completely than smaller areas, since the metal-ion-containing electrolyte may fail to penetrate through narrow regions to repair smaller damaged areas. Higher magnification SEM images in FIGS. 12B-12D show the interface region between the deposited copper and the original metal-ceramic composite. Because the ceramic phase of the composite (e.g., alumina) is not conductive, copper can only deposit on the metal phase (e.g., copper) of the composite. At any given interfacial surface it is likely that metal and ceramic phases are exposed roughly proportional to their volume percentage in the metal-ceramic composite. As can be observed in the region outlined by circle 1208 in FIG. 12C, a roughly continuous metal-metal bond is formed at the interface of the electrodeposited metal and the metal in the composite. The area outlined by rectangle 1210 is an interface between electrodeposited metal and alumina of the composite. FIG. 12D shows a magnified view of this area.

To quantitatively investigate the repair process, flexural tests were performed on the metal-ceramic composite beams. One objective was to measure the electrical resistance of the composite beams before fracture, after fracture, and after the repair process. The composite material includes metal distributed throughout the ceramic matrix structure and thus is electrically conductive, making it possible to compare the electrical resistance of the cracked and repaired composite. To repair the crack after fracture, all surfaces of the composite beams to be exposed to the electrolyte solution, except those defining the crack, were conformally coated with parylene C. Parylene is a commonly used polymer in the electronic industry to provide insulation or a protective chemical barrier. After parylene coating, the fractured surfaces were the only exposed conductive parts in the beam, and hence this approach facilitated local repair of the crack and avoided copper growth elsewhere on the beam. A shadow mask was prepared using Kapton tape to prevent coating of two ends of the beams, which provided two electrically conductive nodes. The first test was to compare the electrical resistance measurements made after fracture. The second test was to measure the electrical resistance after the repair process, which required the use of the two conductive nodes for the electrodeposition process.

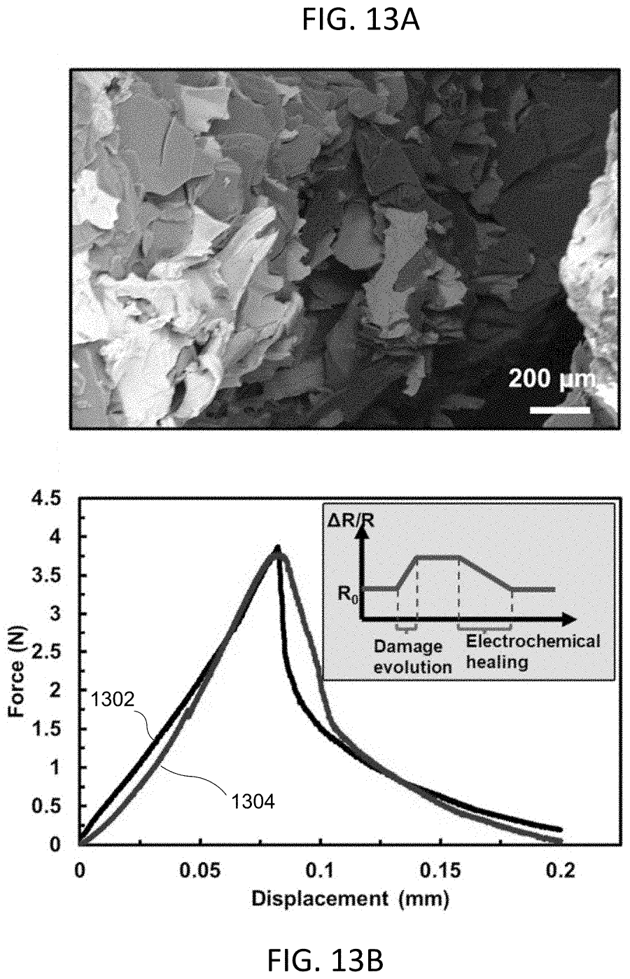

To repair the damaged metal-ceramic composite beam, an electrochemical cell was prepared by placing copper mesh inside a syringe filled with copper electrolyte and connecting the mesh to the counter electrode using a copper wire. To prevent the reduction reaction from happening in this configuration, a plastic Luer lock pipette tip was used. The metal-ceramic composite beam to be repaired was placed on a TEFLON sheet which provided a hydrophobic substrate, preventing the electrolyte from spreading. Both conductive ends of the beams were connected to the working electrode to initiate the electrodeposition and the repair of the crack. In this configuration, applying the same galvanostatic condition as the initial copper infiltration to fabricate the metal-ceramic composite, the copper ions migrated toward the cathode which was formed by the exposed surfaces of the fracture. Once the metal ions reached the conductive regions, the reduction reaction took place and copper metal was deposited at the surfaces of the crack. FIG. 13A is an SEM image of the fracture surface inside a crack. The bright regions are the metal phase, and the dark regions are the ceramic. These copper sites inside the cracks are the exposed surfaces during the repair process from which the metal deposition begins.

FIG. 13B shows representative force-deformation curves of an intact beam 1302 and a repaired beam 1304. The specific strength of the intact beams and repaired beams was

$$8.4 \pm 1.4 \frac{MPa}{gr / {cm}^{3}} , and 6.8 \pm 0.9 \frac{MPa}{gr / {cm}^{3}} ,$$

respectively. The flexural strength of the intact beams and the repaired beams was 31.8±5.5 MPa, and 25.5±3.6 MPa, respectively. The strength recovery was calculated by dividing the strength of the repaired specimen to the strength of the intact specimen. The strength recovery was 82±14%.

The inset in FIG. 13B shows a schematic of electrical resistivity variation during damage evolution and electrochemical repairing. The electrical resistance can be defined as

$$R = \frac{ρ l}{A}$$

where ρ is the resistivity of the material, A is the cross-sectional area and l is the length. The electrical resistance of an intact beam remains constant until damage, which for this example is a crack, initiates and propagates. As the crack propagates the resistance of the metal-ceramic composite beam increases because the cross-sectional area of the beam decreases. Therefore, the change in electrical resistance of the metal-ceramic composite beam can be considered as an indication of damage evolution. After the damage is detected and subsequently repaired by the electrochemical process, the electrical resistance of the beam will decrease to the original value. In this example, the resistance of the metal-ceramic composite beam was measured before fracture, after fracture, and after the repair process. However, the electrical resistance variation can be monitored continuously at least during the initial mechanical test. The electrical resistance of the intact beam, fractured beam, and repaired beam was 10.3±1.2, 16.3±2.5, and 13±2.8 mΩ, respectively. Such large changes in electrical resistance can be detected in applications employing intelligent systems, and are conducive to fully autonomic damage detection and repair.

The specific energy and energy density for the disclosed metal electrodeposition process were calculated to be 636

$$\frac{J}{gr} and 5.6 \frac{kJ}{{cm}^{3}}$$

respectively. In conventional metal-ceramic infiltration processes a furnace is heated up to above the melting temperature of metal. These methods are often assisted with high vacuum. The energy consumption for metal infiltration using conventional metal infiltration process has been estimated to be 428 MJ, with the corresponding specific energy and energy density of

$$39 \frac{kJ}{gr} and 350 \frac{kJ}{{cm}^{3}} .$$

These values only include the heating ramp and dwelling at a certain temperature for metal infiltration and exclude the energy consumption during high vacuum. The results for metal infiltration process to fabricate the metal-ceramic composite show that the disclosed process requires ˜60 times less energy input compared to conventional molten metal infiltration process.

To repair the cracks, the galvanostatic technique was used as the initial metal electrodeposition with a current density of

$$20 \frac{mA}{{cm}^{2}} .$$

The energy consumption to repair the crack was estimated to be

$$1.1 \pm 0.37 \frac{J}{mm} .$$

The disclosed method targeted the repair to an area local to the crack rather than requiring immersion of the entire sample into an electrolyte bath. The localized repair requires less energy consumption than the method requiring total immersion.

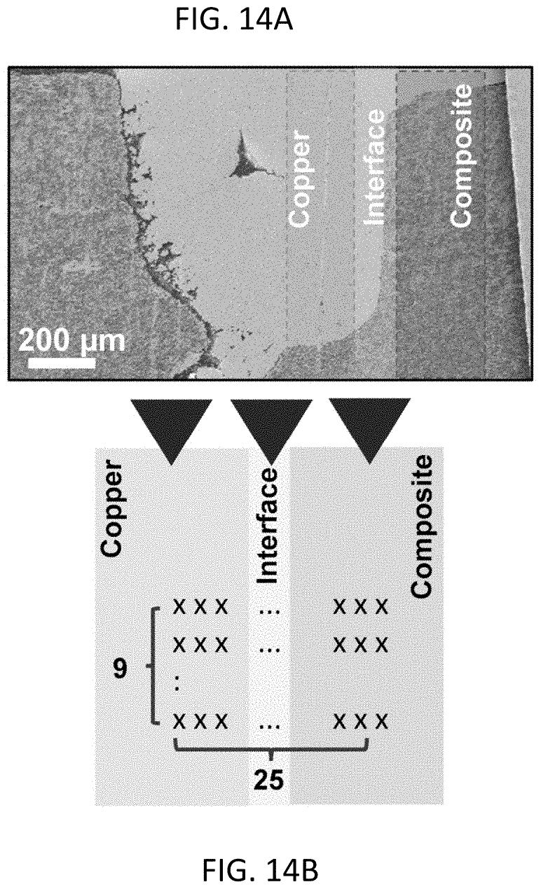

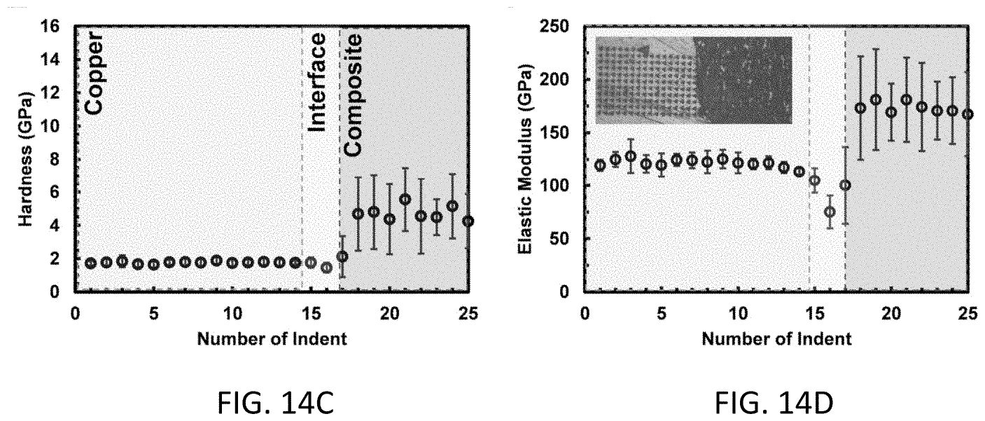

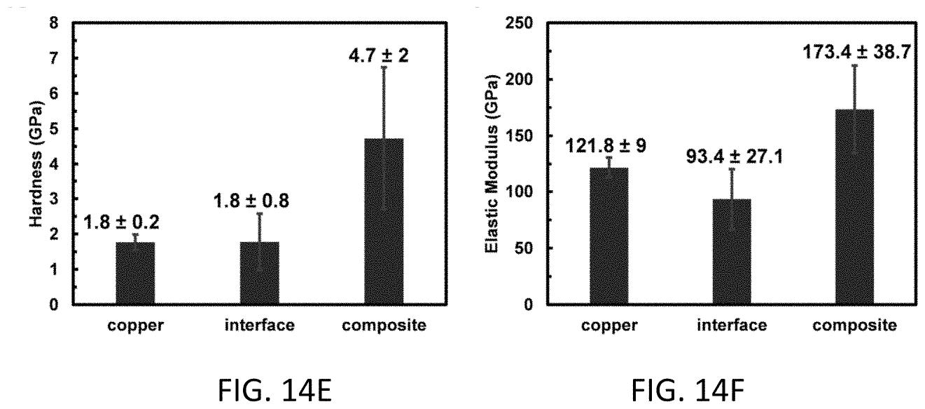

To analyze the performance of the interface between electrodeposited metal and the composite beam, nanoindentation tests were performed. A continuous stiffness measurement technique was used to determine the hardness and elastic modulus of a repaired sample. FIGS. 14A and 14B are an SEM image and a schematic diagram of the sample, respectively, showing the regions of interest in nanoindentation tests. An array of 9 by 25 indentations was generated on the repaired sample. Each row of indentations spanned regions including the electrodeposited metal, the interface between the electrodeposited metal and the composite (which henceforth is called the interface), and the composite. Thus, the electrodeposited metal, the interface, and the composite beam were tested to quantify the performance of the interface. FIGS. 14C and 14D show a line-plot of the hardness and elastic modulus across these three regions. Both plots show a similar trend. The elastic modulus and hardness show nearly constant values on the electrodeposited metal region. There is a slight reduction in the average values of hardness and elastic modulus at the interface region. These plots show the average±standard deviation of nine lines of indentations in the array, each with 25 indentation points. The inset in FIG. 14D is an optical image of the sample showing the rows of indentations.

The values of hardness and elastic modulus of the copper, the interface, and the composite are presented in FIGS. 14E and 14F, respectively. FIG. 14F shows that the indentation modulus of the repaired electrodeposited copper was 121.8±9 which was in the range of electrodeposited copper previously reported as 131±35 GPa. The measured elastic modulus of the composite was 173.4±38.7, which was in good agreement with the calculated elastic modulus of 177 GPa based on the rule of mixture. The large standard deviations in composite properties originate from the randomized organization of the ceramic platelets encased by copper metal, which results in large variation in mechanical properties compared to those of the pure metal region. Unlike elastic modulus, which is an intrinsic property of the material, hardness is an extrinsic property. The hardness of materials depends on many parameters including processing, and thus it can vary accordingly. Depending on the parameters in the electrochemical process, the grain size of the electrodeposited metal can vary. The grain size of the material directly affects the hardness of the material. The measured hardness of the electrodeposited copper in this analysis was 1.8±0.2 GPa, which is in the range of reported values of 1.0-2.2 GPa.

Material Preparation. Ceramic platelets (117751, Rona Flair White Sapphire) were provided by Merck KGaA, Darmstadt, Germany. Alginate (Protanal LF10/60FT) was purchased from FMC Corporation. Fumed colloidal silica (silica≥99%, average diameter of 12 nm, Strem Chemical Inc.) was purchased from VWR. TAC (Ammonium citrate tribasic) was purchased from Sigma Aldrich. Copper plating electrolyte was purchased from Transene Company, Inc.

Ceramic slurry preparation. A 20 vol % aquatic ceramic slurry was prepared using the following ratios. The alumina to alginate ratio was 100:3 wt %, the alumina to fumed colloidal silica ratio was 100:12 wt %, and the ratio of powder to TAC was 100:0.4 wt %. The slurry was prepared by the following steps. First the TAC was added to deionized DI water and mixed using a magnetic stirrer at 400 RPM for one hour to dissolve the powder. Alumina and silica were mixed and divided into five equal containers. All containers were incrementally added to the TAC/DI water solution and mixed using a planetary ball mill at 500 RPM for 30 minutes. Finally, the ceramic slurry was mixed with the same RPM for 12 h to yield a homogeneous ceramic slurry. The pH value of the ceramic slurry was ˜7.5. To obtain a stable ceramic slurry, the pH value was adjusted using HCL (hydrochloric acid) to ˜5.

Freeze casting. A mold containing acrylic walls with a copper bottom plate was made for the unidirectional freeze-casting. The ceramic slurry was poured into the mold and the mold was placed on the cold finger of a homemade freeze-casting setup. The bottom end of the cold finger was submerged into a liquid nitrogen flask. The dimensions of the mold were 150 mm×150 mm×50 mm. To make a large thin sheet of ceramic scaffold, the slurry was poured to the depth of ˜3 mm. After freeze-casting process, the walls of the mold were disassembled while on the cold finger. The large sheet was cut into ˜50 mm×50 mm samples (the thickness of the samples was ˜3 mm) using a sharp razor blade. All samples were freeze-dried in a Labconco FreeZone 2.5 freeze drier for at least 48 h.

Sintering. The freeze-dried sheets were heated in a ST-1700C-445 (Sentro Tech) high temperature box furnace in air environment. The heating process had two steps, a binder burnout step to remove the alginate and a sintering step to transform the green body into solid ceramic. The heating program was as follows: room temperature to 600° C. at 1° C./min; holding at 600° C. for 3 h; from 600° C. to 1600° C. at 1° C./min; holding at 1600° C. for 4 h; from 1600° C. to room temperature at 5° C.

Calculations of density and porosity. For alumina, silica, and copper the density of 3.98, 2.19, and

$$8.96 \frac{gr}{{cm}^{3}}$$

were used, respectively. The density of the MMC was calculated to be

$$3.77 \frac{gr}{{cm}^{3}} .$$

The estimations showed that the MMC had a ceramic phase of 24 vol %, metal phase of 66 vol %, and porosity of 10 vol %.

Estimation of energy consumption during the process. A VersaSTAT-4 Potentiostat/Galvanostat (Princeton Applied Research) controlled the electrochemical cell by applying a constant current (−69 mA). The power was estimated using P=U×I=0.052×0.069=0.0036 W, where U was the average potential, and I, was the constant current. The energy was obtained using E=P×t=0.0036×3600×24×10=3110.4 J. The specific energy was obtained by dividing the energy by the mass of the deposited copper (in this case 4.89 gr) and was

$$636 \frac{J}{gr} .$$

The energy density was obtained by dividing the energy by the volume of the deposited copper (in this case 0.55 cm³) and was

$$5.6 \frac{kJ}{{cm}^{3}} .$$

To calculate the energy consumption for repairing a crack, the energy to repair a crack was divided by the length of the crack for each specimen.

Mechanical characterization. Three-point flexural experiments were chosen to study the mechanical properties of the metal-ceramic composite beams using an MTI/Fullam SEMTester (MTI Instruments, Inc). The span length of the samples was 9.8 mm. The samples were cut into 1 mm×1 mm×15 mm MMC beams. The crosshead displacement rate was 0.1 mm/min. A 5 Ib loadcell was used to capture load-displacement data in mechanical experiments. Eqs. 1 and 2 were used to calculate flexural stress and strain respectively:

$${σ}_{f} = \frac{3 Fl}{2 {bd}^{2}} \qquad ( 1 )$$

$${ϵ}_{f} = \frac{6 Dd}{{l}^{2}} \qquad ( 2 )$$

where F is force, l is the span length, b and d are the width and thickness of the beams, and D is the displacement.

Characterization of rheological properties. The rheological measurements were performed using an Anton Paar rheometer using a 50-mm upper cone with an angle of 0.5° and a 50-mm in diameter lower plate. The viscosity of the ceramic slurry was determined by applying a shear rate sweep from 1000 S⁻¹ to 10⁻¹ S⁻¹.

Scanning electron microscopy. SEM imaging of the ceramic scaffolds and metal-ceramic composite beams was performed using a Zeiss Supra 40 SEM. For ceramic micro platelets and ceramic scaffolds and samples were coated with gold-palladium to enhance their electrical conductivity for SEM imaging.

Nanoindentation experiments. A NanoFlip Nanoindenter (nanomechanics Inc.) equipped with a Berkovich tip was utilized to perform the nanoindentation experiments. The indentation experiments were run in load-control mode. The maximum load was set to 45 mN and the strain rate was set to 0.05 1/s. Each indentation had three stages: loading, holding at maximum load for one second, and unloading. A continuous stiffness measurement (CSM) technique was used to determine the hardness and elastic modulus of the specimen as a function of indentation depth. An array of 9 by 25 indentations was generated on the repaired samples starting from the repaired electrodeposited metal region to the metal-ceramic composite region of the sample.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A metal-ceramic composite comprising:
a ceramic matrix defining a multiplicity of pores; and
a metal electrodeposited in the multiplicity of pores,
wherein the metal-ceramic composite is electrically conductive.

2. The metal-ceramic composite of claim 1, wherein the ceramic matrix comprises alumina.

3. The metal-ceramic composite of claim 1, wherein the metal comprises copper, nickel, gold, platinum, or any alloy thereof.

4. The metal-ceramic composite of claim 1, wherein the multiplicity of pores is filled with the metal.

5. The metal-ceramic composite of claim 1, wherein the metal-ceramic composite further defines microchannels within the metal-ceramic composite.

6. A ceramic slurry comprising:
ceramic microstructures or nanostructures;
silica nanopowder;
a dispersant; and
a binder.

7. The ceramic slurry of claim 6, wherein the ceramic microstructures or nanostructures comprise platelets or whiskers.

8. The ceramic slurry of claim 6, wherein an average length of the microstructures or nanostructures is at least twice an average thickness of the microstructures or nanostructures.

9. The ceramic slurry of claim 6, wherein a pH of the ceramic slurry is in a range of about 5-7.5.

10. The ceramic slurry of claim 6, wherein:
a weight ratio of the silica nanopowder to the ceramic microstructures or nanostructures is in a range of about 0.1 to 0.2;
a weight ratio of the binder to the ceramic microstructures or nanostructures is in a range of about 0.01 to about 0.05; and
a weight ratio of the dispersant to the ceramic microstructures or nanostructures is in a range of about 0.001 to about 0.005.

11. A method of fabricating a metal-ceramic composite, the method comprising:
freeze-casting the ceramic slurry of claim 6 to yield a freeze-cast slurry;
drying the freeze-cast slurry to yield a freeze-dried slurry;
sintering the freeze-dried slurry to yield a ceramic matrix defining a multiplicity of pores; and
electrodepositing metal in the pores, thereby yielding the metal-ceramic composite.

12. The method of claim 11, further comprising compressing the freeze-dried slurry before sintering the freeze-dried slurry to control a density and a size of the pores.

13. The method of claim 12, wherein the compressing occurs perpendicular to a lamellar direction in the freeze-dried slurry, thereby compressing lamellae together to reduce a size of the pores.

14. The method of claim 12, wherein, after the compressing, a porosity of the freeze-dried slurry is in a range of about 30% to about 50%.

15. The method of claim 11, wherein the sintering occurs at a temperature greater than a melting temperature of the silica nanopowder.

16. A method of repairing a void in a metal-ceramic composite, wherein the void is defined by at least a first metal surface and a second metal surface of the metal-ceramic composite, the method comprising:
introducing a solution comprising metal ions into the void; and
electrodepositing the metal ions on the first metal surface and the second surface to yield a metal phase, thereby filling the void.

17. The method of claim 16, wherein introducing the solution into the void comprises positioning the metal-ceramic composite in the solution.

18. The method of claim 16, wherein introducing the solution into the void comprises disposing a drop of the solution in the void.

19. The method of claim 16, wherein introducing the solution into the void comprises flowing the solution through one or more microchannels within the metal-ceramic composite.

20. The method of claim 16, further comprising, before introducing the solution into the void, detecting a presence of the void by assessing a change in electrical resistance of the metal-ceramic composite.

21. The method of claim 20, wherein assessing the change in electrical resistance comprises assessing the change with a sensor.

22. The method of claim 20, further comprising, after detecting the presence of a void, initiating the electrodepositing.

23. The method of claim 16, wherein the metal phase comprises copper, nickel, gold, platinum, or any alloy thereof.

24. The method of claim 16, wherein electrodepositing the metal ions occurs at a temperature in a range of 20° C. to 30° C.

25. The method of claim 16, wherein the void comprises a defect in the metal-ceramic composite.
